(19) United States
(12) Patent Application Publication
(10) Pub. No.: US 2026/0299496 A1
(43) Pub. Date: Oct. 1, 2026

(54) IMAGE FORMING APPARATUS, CONTROL METHOD FOR THE SAME, AND MEDIUM

(71) Applicant: BROTHER KOGYO KABUSHIKI KAISHA, Nagoya (JP)

(72) Inventor: MAKOTO SOUDA, Nagoya (JP)

(73) Assignee: BROTHER KOGYO KABUSHIKI KAISHA, Nagoya (JP)

(21) Appl. No.: 19/566,323

(22) Filed: Mar. 13, 2026

(30) Foreign Application Priority Data
Mar. 25, 2025 (JP) 2025-049770

(51) Int. Cl. G03G 15/00; G03G 15/20; G03G 15/23; G03G 21/16

(52) U.S. Cl. CPC G03G 15/657; G03G 15/2064; G03G 15/234; G03G 15/50; G03G 21/1647; G03G 2215/00586

(57) ABSTRACT

An image forming apparatus including: an image carrier and a transfer roller defining a transfer nip region; a fuser including a heating rotary body and a rotary body defining a fusing nip region; a movable chute; a shifter; and a controller. The controller is capable of executing a first mode in which the controller locates the movable chute at a first position by not driving the shifter. The controller is configured to execute the first mode throughout a period in which printing to a first surface is performed and a sheet is nipped by the image carrier and the transfer roller and nipped by the heating rotary body and the rotary body, or throughout a period in which printing to a second surface is performed and the sheet is nipped by the image carrier and the transfer roller and nipped by the heating rotary body and the rotary body.

### REFERENCE TO RELATED APPLICATIONS

This application claims priority from Japanese Patent Application No. 2025-049770 filed on Mar. 25, 2025. The entire content of the priority application is incorporated herein by reference.

### BACKGROUND ART

An image forming apparatus including a movable chute), a spring, a driving source, and a controller is known. The movable chute is located between a transfer roller and a fuser.

The movable chute is movable between a first position and a second position below the first position. The spring maintains the movable chute at the first position. The driving source, in operation, moves the movable chute from the first position to the second position against a biasing force of the spring.

The controller is capable of executing a mode in which the controller drives the driving source to move the movable chute to the second position, and a mode in which the controller does not drive the driving source to maintain the movable chute at the first position. The controller suppresses an increase in power consumption due to electric supply to the driving source by selecting one of the two modes depending on conditions.

### SUMMARY

Further suppressing of an increase in power consumption is desired.

In view of the above, the present disclosure aims to suppress an increase in power consumption in a shifter configured to move a movable chute.

An image forming apparatus according to aspects of the present disclosure includes: an image carrier; a transfer roller, the transfer roller and the image carrier defining a transfer nip region between the transfer roller and the image carrier; a fuser including a heating rotary body and a rotary body, the heating rotary body and the rotary body defining a fusing nip region between the heating rotary body and the rotary body; a movable chute disposed between the transfer roller and the fuser in a conveyance direction of the sheet, the movable chute being movable between a first position and a second position; a shifter; and a controller. The transfer roller is configured to transfer a toner image on the image carrier to a sheet. The fuser is configured to fuse the toner image transferred to the sheet. The heating rotary body is configured to heat the sheet. The movable chute is configured to guide the sheet. The shifter is configured to move the movable chute. The controller is capable of executing: a first mode in which the controller locates the movable chute at the first position by not driving the shifter; and a second mode in which the controller locates the movable chute at the second position by driving the shifter. The controller is configured to execute the first mode in a double-sided printing in which printing to a first surface of a particular sheet is performed and then printing to a second surface of the particular sheet is performed, in at least one of throughout a period in which the printing to the first surface is performed and in which the particular sheet is nipped by the image carrier and the transfer roller and nipped by the heating rotary body and the rotary body, or throughout a period in which the printing to the second surface is performed and in which the particular sheet is nipped by the image carrier and the transfer roller and nipped by the heating rotary body and the rotary body.

A control method according to aspects of the present disclosure is a control method for an image forming apparatus, the image forming apparatus including: an image carrier; a transfer roller, the transfer roller and the image carrier defining a transfer nip region between the transfer roller and the image carrier; a fuser including a heating rotary body and a rotary body, the heating rotary body and the rotary body defining a fusing nip region between the heating rotary body and the rotary body; a movable chute disposed between the transfer roller and the fuser in a conveyance direction of the sheet, the movable chute being movable between a first position and a second position; and a shifter. The transfer roller is configured to transfer a toner image on the image carrier to a sheet. The fuser is configured to fuse the toner image transferred to the sheet. The heating rotary body is configured to heat the sheet. The movable chute is configured to guide the sheet. The shifter is configured to move the movable chute. The image forming apparatus is capable of executing: a first mode in which the image forming apparatus locates the movable chute at the first position by not driving the shifter; and a second mode in which the image forming apparatus locates the movable chute at the second position by driving the shifter. The method includes executing the first mode in a double-sided printing in which printing to a first surface of a particular sheet is performed and then printing to a second surface of the particular sheet is performed, in at least one of throughout a period in which the printing to the first surface is performed and in which the particular sheet is nipped by the image carrier and the transfer roller and nipped by the heating rotary body and the rotary body, or throughout a period in which the printing to the second surface is performed and in which the particular sheet is nipped by the image carrier and the transfer roller and nipped by the heating rotary body and the rotary body.

A non-transitory and computer-readable medium according to aspects of the present disclosure is a non-transitory and computer-readable medium storing a program executable by a controller of an image forming apparatus, the image forming apparatus including: an image carrier; a transfer roller, the transfer roller and the image carrier defining a transfer nip region between the transfer roller and the image carrier; a fuser including a heating rotary body and a rotary body, the heating rotary body and the rotary body defining a fusing nip region between the heating rotary body and the rotary body; a movable chute disposed between the transfer roller and the fuser in a conveyance direction of the sheet, the movable chute being movable between a first position and a second position; a shifter; and the controller. The transfer roller is configured to transfer a toner image on the image carrier to a sheet. The fuser is configured to fuse the toner image transferred to the sheet. The heating rotary body is configured to heat the sheet. The movable chute is configured to guide the sheet. The shifter is configured to move the movable chute. The controller is capable of executing: a first mode in which the controller locates the movable chute at the first position by not driving the shifter; and a second mode in which the controller locates the movable chute at the second position by driving the shifter. The program is configured to cause the controller to execute the first mode in a double-sided printing in which printing to a first surface of a particular sheet is performed and then printing to a second surface of the particular sheet is performed, in at least one of throughout a period in which the printing to the first surface is performed and in which the particular sheet is nipped by the image carrier and the transfer roller and nipped by the heating rotary body and the rotary body, or throughout a period in which the printing to the second surface is performed and in which the particular sheet is nipped by the image carrier and the transfer roller and nipped by the heating rotary body and the rotary body.

According to the present disclosure, an increase in power consumption in the shifter configured to move the movable chute can be suppressed by performing the first mode in at least one of throughout the period in which the printing to the first surface is performed and in which the particular sheet is nipped by the image carrier and the transfer roller and nipped by the heating rotary body and the rotary body, or throughout the period in which the printing to the second surface is performed and in which the particular sheet is nipped by the image carrier and the transfer roller and nipped by the heating rotary body and the rotary body.

### BRIEF DESCRIPTION OF DRAWINGS

FIG. 1 is a view illustrating an image forming apparatus.

FIG. 2 is an enlarged view of an area around a movable chute located at a first position.

FIG. 3 is an enlarged view of an area around the movable chute located at a second position.

FIG. 4 is a perspective view of the movable chute.

FIG. 5 is a perspective view of a link mechanism and a solenoid actuator.

FIG. 6 is a view illustrating the link mechanism in a case where the movable chute is located at the first position.

FIG. 7 is a view illustrating the link mechanism in a case where the movable chute is located at the second position.

FIG. 8 is a flowchart illustrating a chute switching process.

FIG. 9 is a flowchart illustrating a chute switching process.

FIG. 10 is a flowchart illustrating a chute switching process.

### DESCRIPTION

A first embodiment of the present disclosure will be described in detail with reference to the drawings as appropriate.

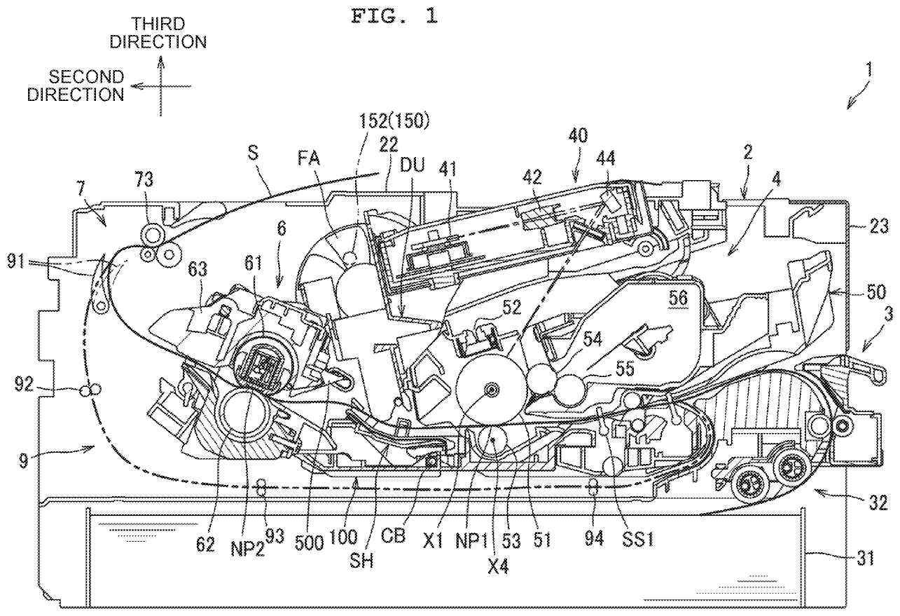

As illustrated in FIG. 1, an image forming apparatus 1 is a laser printer. The image forming apparatus 1 forms an image on a sheet S. The image forming apparatus 1 includes a housing 2, a supply part 3, a process part 4, a fuser 6, and a discharge part 7. The sheet S is an example of a “sheet” and an example of a “particular sheet”.

In the following description, an axial direction of a transfer roller 53 described below is also referred to as a “first direction”. A conveyance direction of a sheet S from the process unit 4 to the fuser 6 is also referred to as a “second direction”. An up-down direction is also referred to as a “third direction”.

The first direction intersects the second direction. The third direction intersects both the first and second directions. In the present embodiment, the first direction is orthogonal to the second direction. The third direction is orthogonal to both the first and second directions. Each of arrows indicating a direction in a drawing extends from a “second side” to a “first side” in the direction, and points to the “first side” in the direction.

The supply part 3 includes a supply tray 31 and a sheet supply device 32. The supply tray 31 accommodates sheets S. The sheet supply device 32 conveys a sheet S in the supply tray 31 to the process part 4.

The process part 4 forms a toner image on a sheet S. The process part 4 includes an exposure device 40 and a process cartridge 50.

The exposure device 40 is disposed at an upper portion inside the housing 2. The exposure device 40 includes a laser light emitter, a polygon mirror 41, a lens 42, and a reflecting mirror 44. Laser light emitted from the laser light emitter is reflected by the polygon mirror 41, then travels through the lens 42, then is reflected by the reflecting mirror 44, and then scans a surface of a photosensitive drum 51 in high speed.

The process cartridge 50 is disposed below the exposure device 40. The process cartridge 50 is attachable and detachable with respect to the housing 2 through an opening defined in a case where a front cover 23 disposed on the housing 2 is opened. The process cartridge 50 includes the photosensitive drum 51, a charger 52, the transfer roller 53, a developing roller 54, a supply roller 55, and a toner container 56. The photosensitive drum 51 is an example of an image carrier.

The photosensitive drum 51 rotates about a rotational axis X1 extending in the first direction. The photosensitive drum 51 carries a toner image.

The transfer roller 53 rotates about a rotational axis X4 extending in the first direction. The transfer roller 53 transfers the toner image on the photosensitive drum 51 to a sheet S. The transfer roller 53 and the photosensitive drum 51 define a transfer nip region NP1 between the transfer roller 53 and the photosensitive drum 51. Here, the transfer nip region NP1 refers to a portion, of the transfer roller 53, in contact with the photosensitive drum 51.

The fuser 6 fuses the toner image transferred onto a sheet S to the sheet S. The fuser 6 is disposed downstream of the process part 4 in a conveyance direction of the sheet S. In the following description, “a conveyance direction of a sheet S” is also referred to simply as “a conveyance direction”. The fuser 6 includes a heating rotary body 61, a pressure rotary body 62, and a fusing housing 63.

The heating rotary body 61 is a member configured to heat a sheet S. The heating rotary body 61 is an endless belt. The heating rotary body 61 accommodates a heater within the heating rotary body 61. The heating rotary body 61 rotates in a state that the sheet S is interposed between the heating rotary body 61 and the pressure rotary body 62.

The pressure rotary body 62 is a member configured to press the sheet S. The pressure rotary body 62 and the heating rotary body 61 define a fusing nip region NP2 between the pressure rotary body 62 and the heating rotary body 61. Here, the fusing nip region NP2 refers to a portion, of the heating rotary body 61, in contact with the pressure rotary body 62. The pressure rotary body 62 is a roller of which surface is a non-conductive elastic body. The heating rotary body 61 and the pressure rotary body 62 are pressed against each other by an un-illustrated pressing member.

The fusing housing 63 is a frame covering the heating rotary body 61 and the pressure rotary body 62. The fusing housing 63 rotatably supports the heating rotary body 61 and the pressure rotary body 62.

In the process part 4, a surface of the photosensitive drum 51 is charged by the charger 52. Subsequently, the surface of the photosensitive drum 51 is exposed with laser light from the exposure device 40. Thus, an electrostatic latent image is formed on the photosensitive drum 51. Toner contained in the toner container 56 is supplied to the developing roller 54 via the supply roller 55 and will be carried on the developing roller 54.

Then, the toner carried on the developing roller 54 is supplied to the electrostatic latent image on the photosensitive drum 51. Thus, the electrostatic latent image is made visible and a toner image is formed on the photosensitive drum 51. Subsequently, a sheet S supplied from the supply part 3 is conveyed to the transfer nip region NP1. As the sheet S passes through the transfer nip region NP1, the toner image on the photosensitive drum 51 is transferred onto the sheet S. Subsequently, the sheet S is conveyed to the fusing nip region NP2. Thus, the toner image having been transferred onto the sheet S is thermally fused.

The discharge part 7 conveys a sheet S to which a toner image has been thermally fused toward an exterior of the housing 2. The discharge part 7 has a discharge roller 73. The discharge roller 73 discharges the sheet S into the discharge tray 22.

The image forming apparatus 1 includes a re-conveyance mechanism 9. The re-conveyance mechanism 9 conveys a sheet S back to the process part 4 in a state that the sheet S is reversed in a thickness direction of the sheet S, after an image has been formed on a surface of the sheet S. Note that in FIG. 1, a sheet S being re-conveyed is indicated with a two-dot chain line.

The re-conveyance mechanism 9 includes a flapper 91 and re-conveyance rollers 92, 93, 94. The flapper 91 is pivotable between an initial position indicated by a solid line and a re-conveyance position indicated by a two-dot chain line. In a case where the flapper 91 is positioned at the initial position, a sheet S discharged from the fuser 6 is guided toward the discharge tray 22. In a case where the flapper 91 is positioned at the re-conveyance position, a sheet S is guided toward the re-convenance route by the discharge roller 73 rotating reversely.

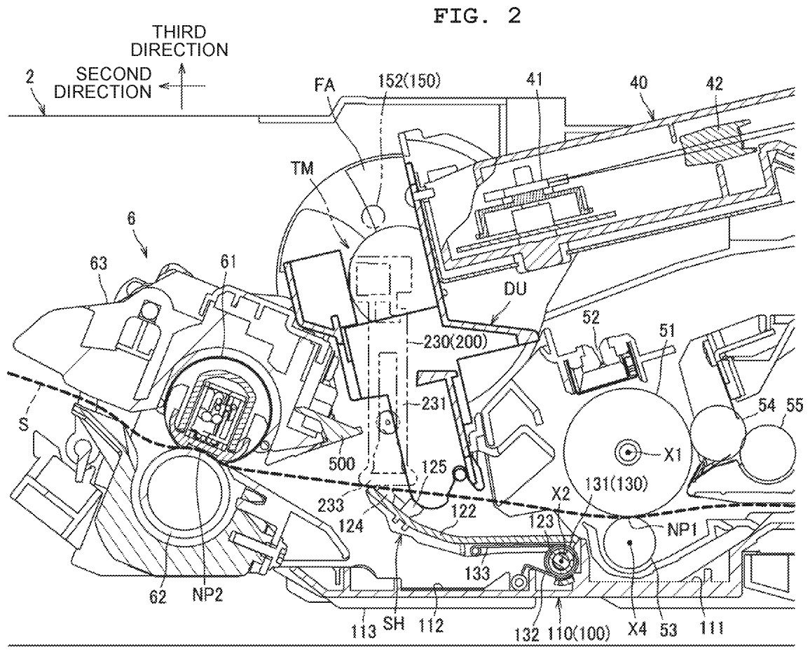

Furthermore, the image forming apparatus 1 includes a guide member 100. The guide member 100 is located below the process cartridge 50 and guides a sheet S from the transfer nip region NP1 toward the fusing nip region NP2. The guide member 100 also guides a sheet S in the re-conveyance route toward the transfer nip region NP1. The re-conveyance route is defined below the guide member 100. As illustrated in FIG. 2, the guide member 100 includes a base 110, a movable chute SH, and springs 130.

The base 110 has a first recess 111, a second recess 112, and a bottom surface 113. The first recess 111 is located at an end on a second side in the second direction on an upper surface of the base 110. The first recess 111 is a portion into which a part of the transfer roller 53 enters. The second recess 112 is located at an end on a first side in the second direction on the upper surface of the base 110. The second recess 112 is a portion that pivotably supports the movable chute SH. The bottom surface 113 is a lower surface of the base 110 and serves as a guide surface configured to guide a sheet S in the re-conveyance path.

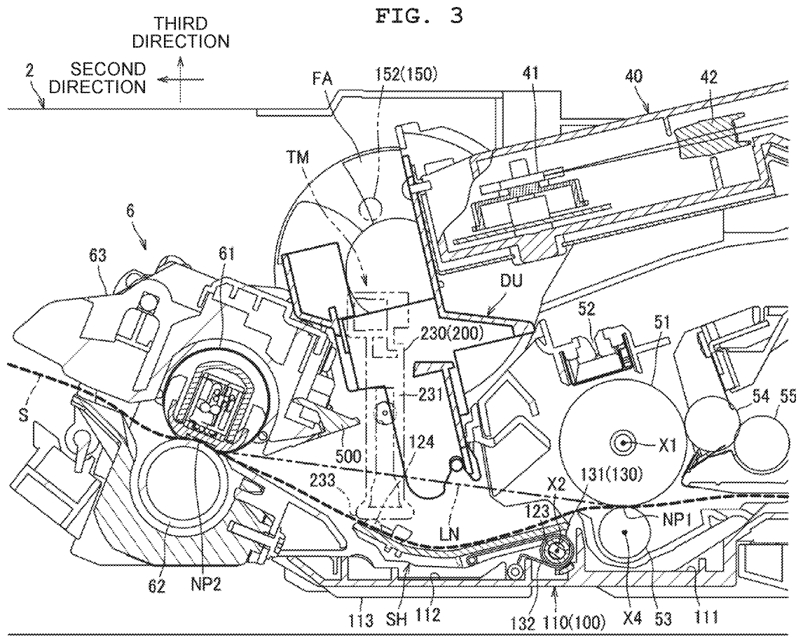

The movable chute SH is located between the transfer roller 53 and the fuser 6 in the conveyance direction of the sheet S. In other words, the movable chute SH is disposed downstream of the transfer roller 53 and upstream of the fuser 6 in the conveyance direction of the sheet S. The movable chute SH guides a sheet S. The movable chute SH is movable between a first position indicated in FIG. 2 and a second position indicated in FIG. 3.

The movable chute SH is movable in a direction crossing a surface of a sheet S. As illustrated in FIG. 3, the second position is farther from a straight line LN than the first position is as viewed in an axial direction of the transfer roller 53. That is, the distance between the second position and the straight line LN as viewed in the axial direction of the transfer roller 53 is larger than a distance between the first position and the straight line LN as viewed in the axial direction of the transfer roller 53. The straight line LN is a line connecting a downstream end in the conveyance direction of the transfer nip region NP1 and an upstream end in the conveyance direction of the fusing nip region NP2. Here, an illustration of the straight line LN is omitted in FIG. 2 since the straight line LN overlaps with a sheet S indicated by a dashed line.

In this embodiment, the second position is located below the first position. The movable chute SH is pivotable about a pivot axis X2 between the first position and the second position.

The movable chute SH extends downstream in the conveyance direction from the pivot axis X2. In a case where the movable chute SH is located at the first position, an end of the movable chute SH, that is, a downstream end in the conveyance direction of the movable chute SH is located above the transfer nip region NP1. In a case where the movable chute SH is located at the second position, the end of the movable chute SH is located below the transfer nip region NP1.

The downstream end in the conveyance direction of the movable chute SH is farther from the straight line LN in a case where the movable chute SH is positioned at the second position than in a case where the movable chute SH is positioned at the first position.

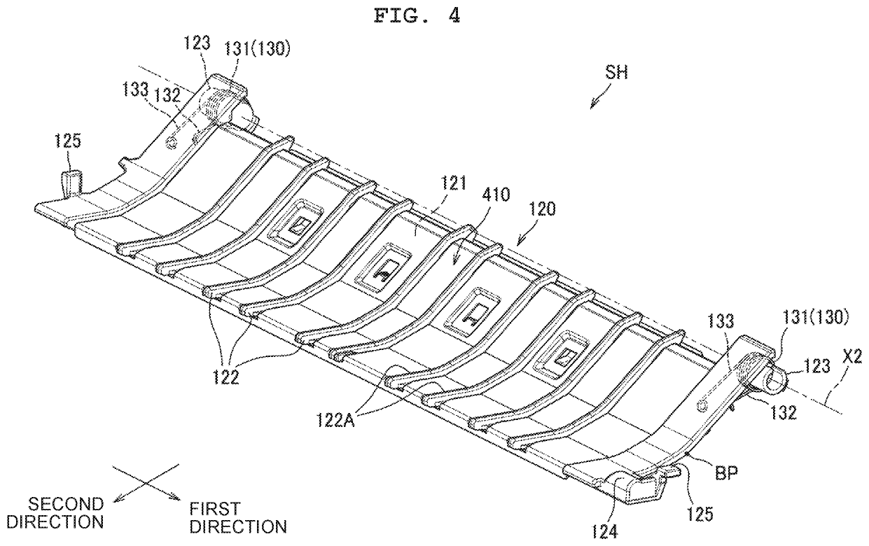

As illustrated in FIG. 4, the movable chute SH includes a chute body 120 and a chute plate 410.

The chute body 120 includes a base 121, a plurality of guide ribs 122, tubular portions 123, a pressure-receiving portion 124, and stoppers 125.

The base 121 has a plate shape curved to recess downward as viewed in the first direction. The base 121 extends in both the first direction and the second direction.

Each of the plurality of guide ribs 122 protrudes upward from the base 121. Each of the plurality of guide ribs 122 extends in the second direction along the curve of the base 121. An upper surface of each of the plurality of guide ribs 122 defines a guide surface 122A configured to guide a sheet S.

The tubular portions 123 are disposed at an end on the second side in the second direction of the base 121. One of the tubular portions 123 is disposed at each end of the movable chute SH in the first direction. The tubular portion 123 has a cylindrical shape of which center is the pivot axis X2. The tubular portion 123 is pivotally supported by the base 110.

The pressure-receiving portion 124 is disposed at an end on the first side in the first direction and on the first side in the second direction of the movable chute SH. The pressure-receiving portion 124 protrudes upward from the base 121. The pressure-receiving portion 124 is a part pressed by a link mechanism 200 described below in a case where the movable chute SH moves from the first position to the second position.

The stoppers 125 contact a duct DU described below to restrict an upward movement of the movable chute SH. The stoppers 125 are located between the tubular portions 123 and the pressure-receiving portion 124 in the second direction. One of the stoppers 125 is disposed at each end in the first direction of the movable chute SH.

Each of the springs 130 is a torsion spring. One of the springs 130 is positioned at each end in the first direction of the movable chute SH. Each of the springs 130 has a coil portion 131, a first arm 132, and a second arm 133. The coil portion 131 engages with an outer side of the tubular portion 123. The first arm 132 extends from the coil portion 131 and hooks onto the base portion 110. The second arm 133 extends from the coil portion 131 and hooks onto the movable chute SH. The springs 130 constantly bias the movable chute SH upward. That is, the springs 130 bias the movable chute SH toward the first position. Thus, in a case where the movable chute SH is not pressed by the link mechanism 200, the movable chute SH is pushed upward by the springs 130, and consequently the stoppers 125 contact the duct DU and the movable chute SH is positioned at the first position.

In a case where the movable chute SH guides a sheet S, the movable chute SH may move slightly against a biasing force of the springs 130 due to, for example, stiffness of the sheet S being conveyed. However, in this embodiment, a slight movement of the movable chute SH caused due to, for example, the stiffness of the sheet S being conveyed is not considered as a movement, and a position of the movable chute SH is regarded as not being changed. That is, even if the movable chute SH moves slightly while guiding a sheet S in a state that the movable chute SH is located at the first position without being pressed by the link mechanism 200, the movable chute SH is considered to be maintained at the first position. Similarly, even if the movable chute SH moves slightly while guiding a sheet S in a state that the movable chute SH is located at the second position pressed by the link mechanism 200, the movable chute SH is considered to be maintained at the second position.

As illustrated in FIG. 2, the image forming apparatus 1 further includes an exhaust fan FA, the duct DU, and a moving device TM. The exhaust fan FA is capable of exhausting air in the housing 2 to an outside of the housing 2. The moving device TM is an example of a “shifter”.

The duct DU is a member configured to guide the air in the housing 2 to the exhaust fan FA in order to exhaust the air in the housing 2 to the outside of the housing 2. Specifically, the duct DU guides the air in the housing 2 from the first side to the second side in the first direction. The duct DU extends in the first direction. The duct DU overlaps with the movable chute SH as viewed in the up-down direction.

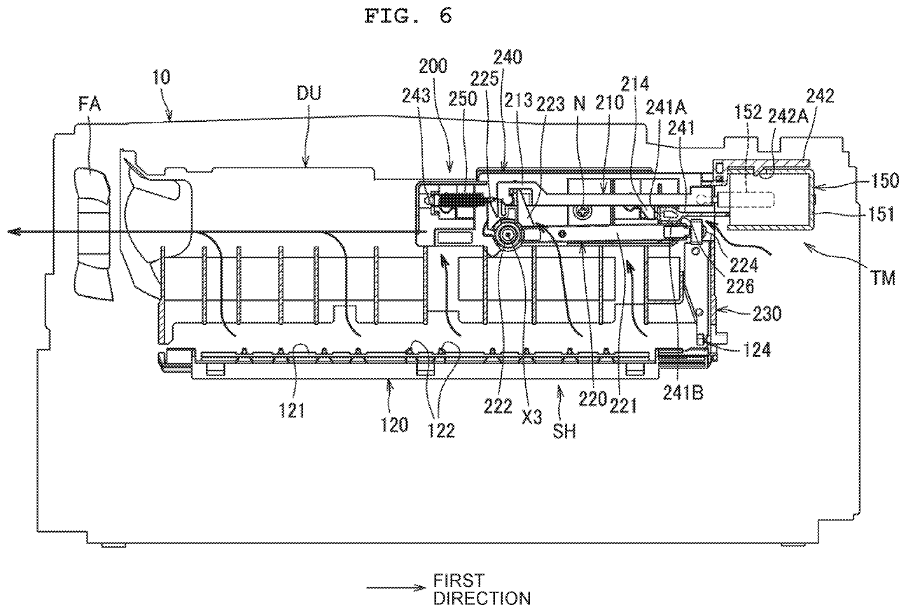

The moving device TM is a device configured to move the movable chute SH. As illustrated in FIG. 6, the moving device TM includes a solenoid actuator 150, a link mechanism 200, and the springs 130 described above. The solenoid actuator 150 is disposed at an end on the first side in the first direction of the duct DU. The exhaust fan FA is disposed at an end on the second side in the first direction of the duct DU. That is, the duct DU is located between the exhaust fan FA and the solenoid actuator 150.

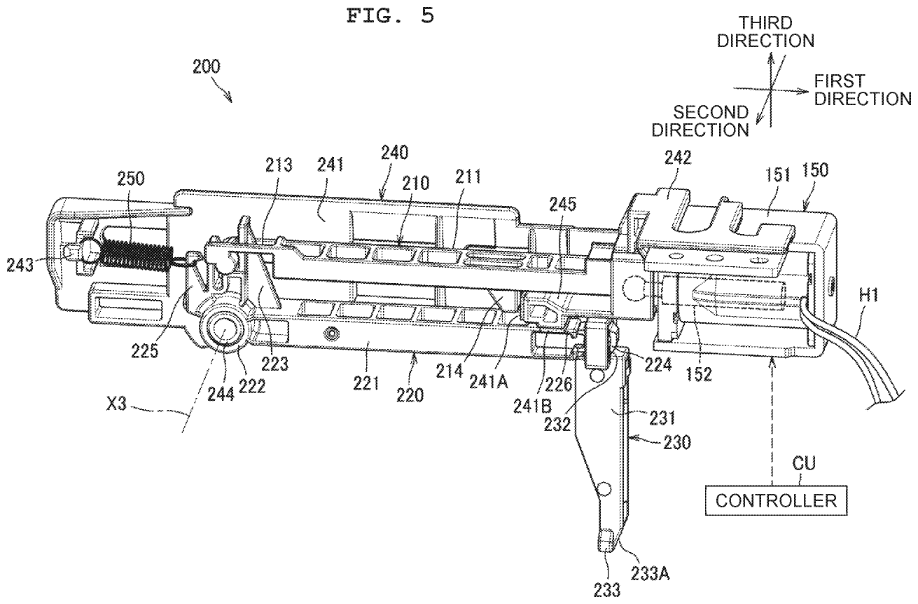

As illustrated in FIG. 5, the solenoid actuator 150 has a main body 151 and a movable part 152. The image forming apparatus 1 further includes a controller CU.

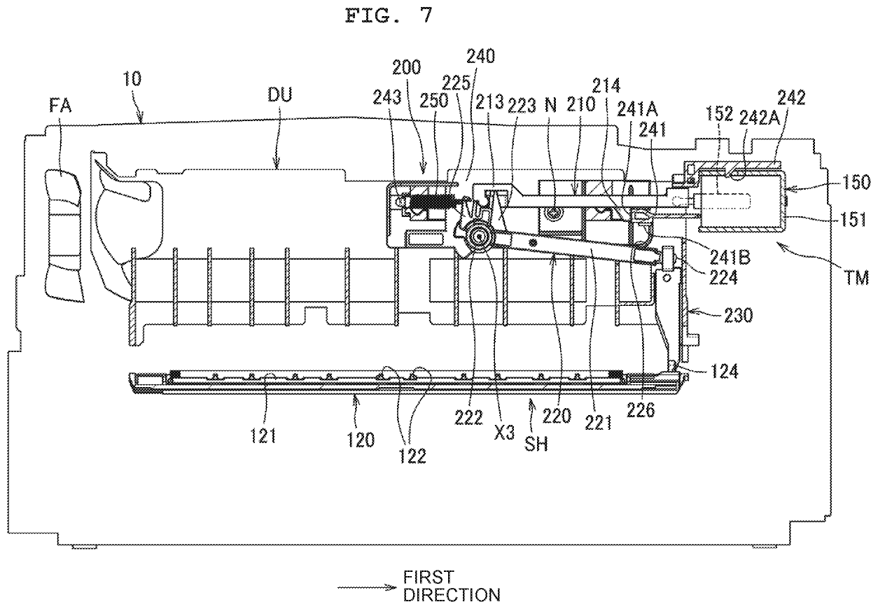

The main body 151 has a rectangular parallelepiped shape. The movable part 152 is a pin movable relative to the main body 151. The movable part 152 is capable of sliding in the first direction. The movable part 152 can move between a forward position indicated in FIG. 6 and a retracted position indicated in FIG. 7. In a case where an ON signal is not sent from the controller CU, the movable part 152 is positioned at the forward position. In a case where the ON signal is sent from the controller CU, the movable part 152 moves from the forward position to the retracted position on the first side in the first direction of the forward position by being pulled with an electromagnetic force. In a case where the ON signal from the controller CU ceases, the movable part 152 returns to the forward position due to a biasing force of a coil spring 250 described below. In a case where the movable part 152 is located at the forward position, the movable chute SH is located at the first position. In a case where the movable part 152 is located at the retracted position, the movable chute SH is located at the second position.

As illustrated in FIG. 5, the link mechanism 200 is a mechanism configured to be moved by a driving force of the solenoid actuator 150. The link mechanism 200 includes a first link 210, a second link 220, a third link 230, a holder 240, and a coil spring 250.

The holder 240 holds the first link 210, the second link 220, and the third link 230. The holder 240 is supported by the duct DU. The holder 240 has a base 241, an extending portion 242, a first hook 243, a boss 244, and an abutment portion 245.

The base 241 extends in the first direction. The extending portion 242 extends upward and to the first side in the first direction from an end on the first side in the first direction of the base 241. The extending portion 242 covers a portion of an upper side of the main body 151 of the solenoid actuator 150. As illustrated in FIG. 6, the extending portion 242 has an engagement claw 242A that protrudes downward. The engagement claw 242A engages with an upper surface of the main body 151 of the solenoid actuator 150. Thus, a position of the holder 240 is set relative to the solenoid actuator 150 in the first direction.

The first hook 243 is located at an end on the second side in the first direction of the base 241. One end of the coil spring 250 engages with the first hook 243.

As illustrated in FIG. 5, the boss 244 is disposed at an end on the second side in the first direction of the base 241. The boss 244 is a cylindrical protrusion protruding from the base 241 toward the first side in the second direction. The boss 244 pivotably supports the second link 220.

The abutment portion 245 is disposed between the extending portion 242 and the boss 244 in the first direction. The abutment portion 245 is a protrusion extending from the base 241 toward the first side in the second direction. The abutment portion 245 has a first abutment surface 241A and a second abutment surface 241B. A sponge is attached to a surface of each of the first abutment surface 241A and the second abutment surface 241B. Each sponge is configured to be compressed to a predetermined thickness by being pressed with the first link 210 or the second link 220.

The first abutment surface 241A faces the second side in the first direction. The first abutment surface 241A contacts the first link 210 via the sponge in a case where the movable part 152 moves from the forward position to the retracted position.

The second abutment surface 241B faces downward. The second abutment surface 241B is a surface configured to contact the second link 220 via the sponge in a case where the movable part 152 moves from the retracted position to the forward position.

The first link 210 is connected to the movable part 152 of the solenoid actuator 150. The first link 210 slides in the first direction together with the movable part 152 in a case where the movable part 152 moves in the first direction. The first link 210 extends in the first direction. The first link 210 has a base 211, a first hole 213, and a first protrusion 214.

The base 211 has a rectangular rod shape extending in the first direction. An end on the first side in the first direction of the base 211 is connected to an end of the movable part 152 of the solenoid actuator 150. Thus, in a case where the movable part 152 moves in the first direction, the first link 210 also moves in the first direction in accordance with the movement of the movable part 152.

The first hole 213 is disposed at an end on the second side in the first direction of the base 211. The first hole 213 is a rectangular hole extending through the base 211 in the up-down direction.

The first protrusion 214 extends downward from an end on the first side in the first direction of the base 211. The first protrusion 214 is positioned on the first side in the first direction of a center in the first direction of the base 211. The first protrusion 214 contacts the first abutment surface 241A of the holder 240 via the sponge in a case where the movable part 152 moves from the forward position to the retracted position.

The second link 220 is connected to an end on the second side in the first direction of the first link 210. The second link 220 pivots about the first axis X3 in a case where the first link 210 moves in the first direction. The second link 220 is located below the first link 210. The second link 220 has a base 221, a cylindrical portion 222, a second protrusion 223, a third protrusion 224, a second hook 225, and a third abutment surface 226.

The base 221 has a rectangular rod shape extending in the first direction. The cylindrical portion 222 is disposed at an end on the second side in the first direction of the base portion 221. The cylindrical portion 222 has a cylindrical shape. The boss 244 of the holder 240 is entered into an inside of the cylindrical portion 222. In a state that the boss 244 is entered into the cylindrical portion 222, the second link 220 is pivotable about the first axis X3.

The second protrusion 223 protrudes upward from an outer circumferential surface of the cylindrical portion 222. The second protrusion 223 enters into the first hole 213 of the first link 210. Thus, the second link 220 is connected to the end on the second side in the first direction of the first link 210 and can pivot about the first axis X3 based on movement of the first link 210. Specifically, in a case where the first link 210 moves toward the first side in the first direction, the first link 210 presses the second protrusion 223 toward the first side in the first direction, causing the second link 220 to pivot clockwise in FIG. 5.

The third protrusion 224 protrudes from an end on the first side in the first direction of the base 221 toward the first side in the first direction. The third protrusion 224 is connected to the third link 230.

The second hook 225 protrudes upward from the outer circumferential surface of the cylindrical portion 222. The second hook 225 is disposed on the second side in the first direction of the second protrusion 223. The other end of the coil spring 250 engages with the second hook 225.

The third abutment surface 226 is a surface located on an upper side of an end on the first side in the first direction of the base 221. The third abutment surface 226 abuts against the second abutment surface 241B via the sponge in a case where the second link 220 pivots counterclockwise in FIG. 5 and rises. The abutment of the third abutment surface 226 against the second abutment surface 241B prevents the second link 220 from pivoting further.

The third link 230 is connected to the second link 220. In a case where the second link 220 pivots, the third link 230 slides in the up-down direction corresponding to an up-down movement of the third protrusion 224 of the second link 220. Specifically, the third link 230 can move between a pressing position and a tolerance position based on the pivot of the second link 220. In a case where the third link 230 is positioned at the pressing position, the third link 230 pushes the movable chute SH down to the second position. In a case where the third link 230 is positioned at the tolerance position, the third link 230 does not push down the movable chute SH, and allows the movable chute SH to remain at the first position. The third link 230 extends in the up-down direction and is disposed below the second link 220. The third link 230 has a base 231, a third hole 232, and a chute pressing portion 233.

The base 231 has a rectangular rod shape extending in the up-down direction. The base portion 231 is supported on the housing 2, such as the duct DU, in a state that the base 231 is movable in the up-down direction.

The third hole 232 is a rectangular hole located at an upper end of the third link 230. The third protrusion 224 of the second link 220 enters into the third hole 232. Thus, in a case where the second link 220 pivots, the third link 230 slides in the up-down direction.

The chute pressing portion 233 has a pressing surface 233A configured to press the movable chute SH downward. The pressing surface 233A presses the movable chute SH from a side, of the movable chute SH, in which the guide surface 122A locates, that is, from above. The chute pressing portion 233 is located at a lower end of the third link 230. In a case where the third link 230 moves downward, the chute pressing portion 233 contacts the pressure-receiving portion 124 of the movable chute SH and presses the movable chute SH downward.

The coil spring 250 is a tension spring that constantly pulls the second link 220 toward the second side in the first direction. Furthermore, the coil spring 250 constantly pulls the first link 210 toward the second side in the first direction via the second link 220.

As illustrated in FIG. 6, the movable part 152 is located at the forward position in a case where the ON signal is not sent from the controller CU. In a case where the ON signal is sent from the controller CU, the movable part 152 is pulled and moves from the forward position to the retracted position. As illustrated in FIG. 7, in a case where the movable part 152 moves from the forward position to the retracted position, the first link 210 slides together with the movable part 152 to the first side in the first direction. In a case where the first link 210 slides to the first side in the first direction, the second protrusion 223 of the second link 220 is pushed to the first side in the first direction by the first link 210. In a case where the second protrusion 223 is pushed to the first side in the first direction, the second link 220 pivots clockwise in FIG. 7. In a case where the second link 220 pivots clockwise, the third protrusion 224 pushes the third link 230 downward. In a case where the third link 230 is pushed downward, the third link 230 pushes the pressure-receiving portion 124 of the movable chute SH downward. Thus, the movable chute SH moves from the first position to the second position against the biasing force of the springs 130.

In a case where the ON signal is no longer sent from the controller CU, the second link 220 rotates counterclockwise from the state illustrated in FIG. 7 due to the biasing force of the coil spring 250. In a case where the second link 220 pivots counterclockwise, as illustrated in FIG. 6, the third link 230 is pulled upward by the third protrusion 224 of the second link 220. In a case where the third link 230 is pulled upward, the third link 230 moves from the pressing position to the tolerance position, and the chute pressing portion 233 no longer presses the pressure-receiving portion 124 of the movable chute SH. In a case where the third link 230 moves to the tolerance position, the movable chute SH moves from the second position to the first position due to the biasing force of the springs 130. In a case where the second link 220 pivots counterclockwise, the second protrusion 223 of the second link 220 pulls the first link 210 toward the second side in the first direction. In a case where the first link 210 is pulled toward the second side in the first direction, the movable part 152 is pulled toward the second side in the first direction together with the first link 210, and returns to the forward position.

The controller CU includes, for example, a CPU, a RAM, a ROM, and input-output circuit. The controller CU executes control by performing various computational processes based on programs and data stored in, for example, the ROM.

The controller CU is capable of executing a first mode and a second mode. The first mode is a mode in which the moving device TM is not driven during a conveyance of a sheet S and consequently the sheet S is guided by the movable chute SH located at the first position. Specifically, the controller CU executes the first mode by not supplying electric to the solenoid actuator 150.

The second mode is a mode in which the moving device TM is driven during a conveyance of a sheet S to move the movable chute SH from the first position to the second position. Specifically, the controller CU executes the second mode by supplying electric to the solenoid actuator 150.

The controller CU is capable of executing a double-sided printing process of performing printing on a first surface of a sheet S and then performing printing on a second surface of the sheet S. In a case where the controller CU performs the double-sided printing process for a single sheet S, the controller CU executes the following process. In a case where the controller CU starts printing on the first surface, the controller CU executes the second mode. In a case where the controller CU starts printing on the second surface, the controller CU executes the first mode.

Here, a timing at which the second mode is started, that is, an electric supply start timing at which electric supply to the solenoid actuator 150 is started can be set, for example, as follows. The electric supply start timing can be set to any timing between a timing at which a front end (that is, a downstream end in the conveyance direction) of a sheet S reaches the fusing nip region NP2 and a timing at which a rear end (that is, an upstream end in the conveyance direction) of the sheet S leaves the transfer nip region NP1. That is, the electric supply start timing can be set to any timing in a period in which a sheet S is nipped by the photosensitive drum 51 and the transfer roller 53 and nipped by the heating rotary body 61 and the rotary body 62. The electric supply start timing can be set to any timing before a force applied to the movable chute SH from a sheet S, which deflects between the fusing nip region NP2 and the transfer nip region NP1, reaches a predetermined value or exceeds the predetermined value. The electric supply start timing can be appropriately set based on, for example, experiments.

A timing at which the first mode is started, that is, an electric supply end timing at which the electric supply to the solenoid actuator 150 is cut off, can be set, for example, as follows. The electric supply end timing can be set to any timing between a timing at which a rear end of a sheet S, which is in a process of fusing a toner image onto a first surface of the sheet S, leaves the transfer nip region NP1, and a timing at which a front end of the sheet S having passed through the re-conveyance route leaves the transfer nip region NP1. The earlier the electric end timing, the better.

For example, the electric supply end timing can be set to any timing between a timing at which the rear end of the sheet S, which is in the process of fusing the toner image on the first surface of the sheet S, leaves the transfer nip region NP1 and a timing at which the rear end of the sheet S reaches the fusing nip region NP2. Note that in a case where the rear end of the sheet S, which is in the process of fusing the toner image onto the first surface of the sheet S, leaves the transfer nip region NP1, the movable chute SH, for example, can be moved to prepare for printing onto a second surface of the sheet S. Therefore, a case in which the rear end of the sheet S, which is in the process of fusing the toner image onto the first surface of the sheet S, leaves the transfer nip region NP1, corresponds to a case in which printing onto the second surface of the sheet S is started.

The controller CU is capable of executing a single-side printing process of printing only a first surface of a sheet S. In a case where the controller CU receives a single-side printing instruction as a printing instruction, the controller CU executes, for a single sheet, the second mode and then the first mode after the second mode. Therefore, in a case where the controller CU performs the single-side printing for a plurality of sheets S, the controller CU executes the second mode and then the first mode for each of the plurality of sheets S.

The controller CU determines the electric supply start timing and the electric supply end timing based on information from, for example, a sheet sensor SS1 illustrated in FIG. 1. The sheet sensor SS1 is a sensor configured to detect a sheet S. The sheet sensor SS1 is disposed upstream of the fuser 6, specifically upstream of the transfer roller 53 in the conveyance direction. The sheet sensor SS1 can detect a sheet S supplied from the supply tray 31. The sheet sensor SS1 can detect a sheet S that has passed through the re-conveyance route.

The controller CU determines whether the electric supply start timing has been reached by determining whether a first time interval has elapsed since detection of a sheet S by the sheet sensor SS1. The controller CU determines whether the electric supply end timing has been reached by determining whether a second time interval has elapsed since detection of a sheet S by the sheet sensor SS1.

In a case where the controller CU performs the double-sided printing process to a plurality of sheets S, the controller CU performs printing for each sheet S in an order of a first surface, then a second surface. For example, in a case where image data for four pages are printed, the controller CU performs printing in an order of a second page, a first page, a fourth page, and a third page. In other words, in a case where a second sheet is conveyed after a first sheet in the double-sided printing process, the controller CU performs printing on a first surface and a second surface of the first sheet in this order, and then performs printing on a first surface and a second surface of the second sheet in this order.

In a case where the controller CU conveys the second sheet after the first sheet in the double-sided printing process, the controller CU executes the following process. The controller CU executes the second mode in a case where the controller CU starts printing to the first surface of the first sheet. The controller CU executes the first mode in a case where the controller CU starts printing to the second surface of the first sheet. The controller CU executes the first mode in a case where the controller CU starts printing to the first surface of the second sheet. The controller CU executes the first mode in a case where the controller CU starts printing to the second surface of the second sheet.

In other words, in a case where the controller CU performs the double-sided printing process to a plurality of sheets S, the controller CU executes the second mode in a case where the controller CU performs printing on a first surface of a sheet S being a first piece of the plurality of sheets S. The controller CU switches to the first mode in a case where the controller CU performs printing to a second surface of the sheet S being the first piece of the plurality of sheets S and then maintains the first mode thereafter.

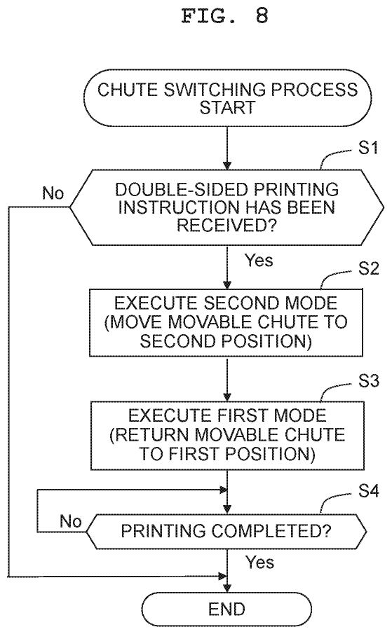

Next, an operation of the controller CU will be described in detail. The controller CU repeatedly executes a chute switching process illustrated in FIG. 8.

In the chute switching process, the controller CU first determines whether the double-sided printing instruction has been received (step S1). In a case where the controller CU determines in the step S1 that the double-sided printing instruction has not been received (step S1: No), the controller CU terminates the process.

In a case where the controller CU determines in the step S1 that the double-sided printing instruction has been received (step S1: Yes), the controller CU executes the second mode (step S2). Specifically, in the step S2, the controller CU determines whether the electric supply start timing has been reached. In a case where the controller CU determines that the electric supply start timing has been reached, the controller CU starts electric supply to the solenoid actuator 150.

After the step S2, the controller CU executes the first mode (step S3). Specifically, in the step S3, the controller CU determines whether the electric supply end timing has been reached. In a case where the controller CU determines that the electric supply end timing has been reached, the controller CU stops electric supply to the solenoid actuator 150.

After the step S3, the controller CU determines whether printing has been completed (step S4). In a case where the controller CU determines in the step S4 that printing has not been completed (step S4: No), that is in a case where a number of printing indicated by the printing instruction is plural, the controller CU repeats the process of the step S4. In a case where the controller CU determines in the step S4 that printing has been completed (step S4: Yes), the controller CU terminates the process.

Next, a specific example of an operation of the controller CU will be described. As illustrated in FIG. 1, in a standby state before the controller CU receives the double-sided printing instruction, the movable chute SH is located at the first position. In a case where the controller CU receives the double-sided printing instruction, the controller CU performs a warm-up operation in which the heater of the fuser 6 is turned on and a temperature of the heating rotary body 61 is raised to a predetermined fusing temperature.

In this embodiment, a situation is assumed as follows. That is, during the warm-up operation, the fuser 6 is not sufficiently heated, and a diameter of the pressure rotary body 62 is a predetermined value or less. After completing the warm-up operation, the controller CU starts to supply a sheet S from the supply part 3.

The sheet S supplied from the supply part 3 passes through the sheet sensor SS1 and then passes through the transfer nip region NP1. As the sheet S passes through the transfer nip region NP1, a toner image is transferred onto a first surface of the sheet S.

A front end of the sheet S having left the transfer nip region NP1 is guided to the fusing nip region NP2 by the movable chute SH located at the first position. After the front end of the sheet S has reached the fusing nip region NP2, in a case where the electric supply start timing has been reached, controller CU starts electric supply to the solenoid actuator 150.

Thus, as illustrated in FIG. 3, the movable chute SH moves to the second position. Regarding the sheet S of which front end has reached the fusing nip region NP2, a conveyance speed of the front end of the sheet S is smaller than a conveyance speed of a rear end of the sheet S due to a small diameter of the pressure rotary body 62. Thus the sheet S deflects downward. However, the deflection of the sheet S is absorbed by a space between the straight line LN and the movable chute SH since the movable chute SH is located at the second position.

In a case where the electric supply end timing, set as a timing after the rear end of the sheet S has reached the fusing nip region NP2, has been reached, the controller CU stops electric supply to the solenoid actuator 150. Thus, as illustrated in FIG. 2, the movable chute SH moves to the first position.

The sheet S having left the fuser 6 is pulled into the housing 2 with an invert rotation of the discharge roller 73, after a portion of the sheet S has been sent out of the housing 2 by the discharge roller 73. Then, the sheet S travels through the long re-conveyance route, and passes through the sheet sensor SS1 and the transfer nip region NP1 again.

As the sheet S passes through the transfer nip region NP1, a toner image is transferred onto a second surface of the sheet S. The front end of the sheet S having left the transfer nip region NP1, is guided to the fusing nip region NP2 by the movable chute SH located at the first position.

Since a long time has elapsed after the sheet S has left the fuser 6 and until the sheet S reaches the fuser 6 again, the fuser 6 will be sufficiently heated. Thus, the diameter of the pressure rotary body 62 becomes larger than the predetermined value.

Thus, even after the front end of the sheet S has reached the fusing nip region NP2, a difference between the conveyance speed of the front end of the sheet S and the conveyance speed of the rear end of the sheet S is small, and the sheet S is less likely to bend downward. Therefore, in a case where printing is performed on the second surface of the sheet S, the sheet S can be guided by the movable chute SH located at the first position.

According to the present embodiment, the following effects can be achieved. By executing the first mode in the case where printing is performed on the second surface of the sheet S in the double-sided printing process, a time during which the moving device TM is not driven can be increased compared to, for example, a configuration in which the second mode is executed for each surface of the sheet S. Thus, an increase in power consumption by the moving device TM can be suppressed.

Next, a second embodiment will be described in detail with reference to the drawings as appropriate. Since the second embodiment is obtained by modifying the processes performed by the controller CU of the first embodiment, configurations and processes of the second embodiment substantially identical to the configurations and the processes of the first embodiment are indicated by reference numerals identical to those of the first embodiment, and descriptions therefor are omitted.

In the second embodiment, in a case where the controller CU performs the double-sided printing process to a single sheet S or a plurality of sheets S, the controller CU executes processes described below. In a case where the controller CU starts printing on a first surface, the controller CU executes the first mode. In a case where the controller CU starts printing on a second surface, the controller CU executes the first mode. That is, in a case where the controller CU receives the double-sided printing instruction, the controller CU does not supply electric to the solenoid actuator 150 and maintains the movable chute SH at the first position until the printing is completed.

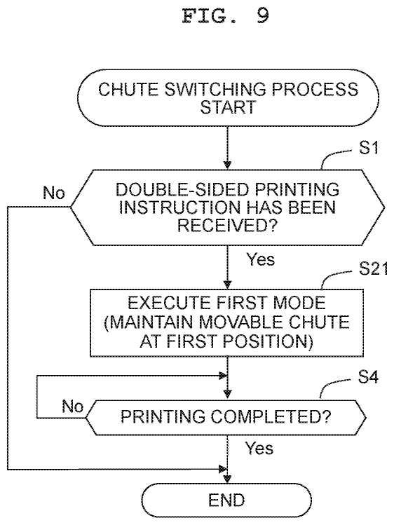

Specifically, the controller CU executes a chute switching process illustrated in FIG. 9. The flowchart in FIG. 9 has a new step S21 instead of the steps S2 and S3 in the flowchart of FIG. 8.

In a case where the controller CU determines in the step S1 that the controller CU has received the double-sided printing instruction (step S1; Yes), the controller CU executes the first mode (step S21). After the step S21, the controller CU proceeds to the step S4.

In the second embodiment, since the controller CU executes the first mode for both first and second sides of a sheet S, an increase in power consumption by the moving device TM can be suppressed more effectively. Note that the control of the second embodiment is effective in a case where the fuser 6 is sufficiently heated during a warm-up operation and the diameter of the pressure rotary body 62 becomes larger than a predetermined value.

Next, a third embodiment will be described in detail with reference to the drawings as appropriate. Since the third embodiment is obtained by modifying the processes performed by the controller CU of the first embodiment, configurations and processes of the third embodiment substantially identical to the configurations and the processes of the first embodiment are indicated by reference numerals identical to those of the first embodiment, and descriptions therefor are omitted.

In the third embodiment, in a case where the controller CU performs the double-sided printing process on a single sheet S, the controller CU executes processes described below. In a case where the controller CU starts printing to a first surface, the controller CU executes the first mode. In a case where the controller CU starts printing to a second surface, the controller CU executes the second mode.

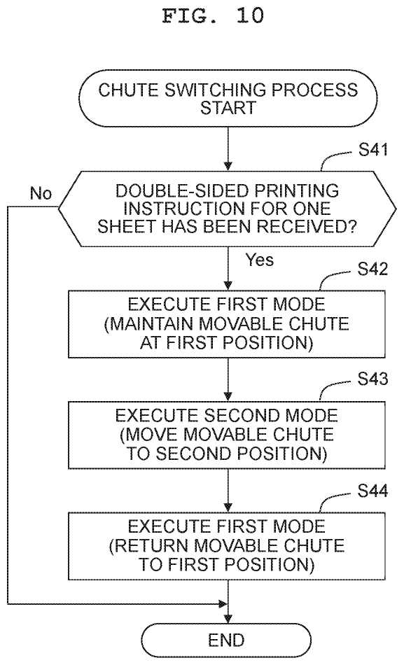

Specifically, the controller CU executes a chute switching process illustrated in FIG. 10. In the chute switching process in FIG. 10, the controller CU first determines whether the controller CU has received the double-sided printing instruction for a single sheet S (step S41). In a case that the controller CU determines that the controller CU has not received the double-sided printing instruction (step S41: No), the controller CU terminates the process.

In a case where the controller CU determines in the step S41 that the controller CU has received the double-sided printing instruction (step S41: Yes), the controller CU executes the first mode (step S42). Specifically, in the step S42, the controller CU does not supply electric to the solenoid actuator 150 to maintain the movable chute SH at the first position.

After the step S42, the controller CU executes the second mode (step S43). Specifically, in the step S43, the controller CU determines the electric supply start timing. In a case where the controller CU determines that the electric supply start timing has been reached, the controller CU starts electric supply to the solenoid actuator 150.

After the step S43, the controller CU executes the first mode (step S44) and terminates the process. Specifically, in the step S44, the controller CU determines the electric supply end timing. In a case where the controller CU determines that the electric supply end timing has been reached, the controller CU stops electric supply to the solenoid actuator 150.

The control of the third embodiment is effective in a case where two conditions described below are satisfied. (1) The fuser 6 is heated sufficiently in a warm-up operation, and the diameter of the pressure rotary body 62 becomes larger than a predetermined value. (2) Heat of the pressure rotary body 62 is absorbed by the sheet S in fusing of a first surface of the sheet S, and the diameter of the pressure rotary body 62 becomes a predetermined value or less.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The image carrier is not limited to the photosensitive drum. The image carrier may, for example, be an intermediate transfer belt onto which a toner image is transferred from the photosensitive drum. In this case, the transfer roller transfers the toner image on the intermediate transfer belt onto a sheet. The transfer roller defines a transfer nip region with the intermediate transfer belt.

The heating rotary body may be any structure whose periphery in contact with a sheet rotates. The heating rotary body may be a heating roller. The pressure rotary body may be any structure whose periphery in contact with a sheet rotates. The pressure rotary body may be an endless belt interposed between a heating roller and a rubber pad.

The second position may be a position above the first position. In this case, the moving device may push the movable chute upward. Furthermore, in this case, since the moving device supports the movable chute from below, a spring biasing the movable chute toward the first position may be omitted.

The moving device may have a configuration including a motor and a rack-and-pinion mechanism. The moving device may be connected to the movable chute.

The spring is not limited to the torsion spring. For example, the spring may be a compression coil spring, a tension coil spring, or a leaf spring.

The movable chute may be movable linearly. The end of the movable chute (that is, the downstream end in the conveyance direction of the movable chute in the above embodiments) may face upstream in the conveyance direction.

A timing for starting electric supply to the solenoid actuator may be any timing after a front end of a sheet has reached the transfer nip region. For example, the controller CU may start electric supply to the solenoid actuator at a timing just before the front end of the sheet reaches the fusing nip region.

Electric current flowing to the solenoid actuator may be controlled by any control method, without being limited to duty control. For example, control in which electric current flowing to the solenoid actuator is gradually reduced may be used.

The structure for pushing a movable chute against a biasing force of a spring is not limited to the structure in the aforementioned embodiment. For example, a structure in which a movable chute is pushed directly by a solenoid actuator may be used.

The image forming apparatus is not limited to a laser printer, but may also be, for example, a copier or a multi-function peripheral.

The elements described in the above embodiments and modifications may be implemented in any combination.

What is claimed is

1. An image forming apparatus, comprising:
an image carrier;
a transfer roller, the transfer roller and the image carrier defining a transfer nip region between the transfer roller and the image carrier;
a fuser including:
a heating rotary body; and
a rotary body, the heating rotary body and the rotary body defining a fusing nip region between the heating rotary body and the rotary body;
a movable chute disposed between the transfer roller and the fuser in a conveyance direction of the sheet, the movable chute being movable between a first position and a second position;
a shifter; and
a controller, wherein
the transfer roller is configured to transfer a toner image on the image carrier to a sheet,
the fuser is configured to fuse the toner image transferred to the sheet,
the heating rotary body is configured to heat the sheet,
the movable chute is configured to guide the sheet,
the shifter is configured to move the movable chute,
the controller is capable of executing:
a first mode in which the controller locates the movable chute at the first position by not driving the shifter; and
a second mode in which the controller locates the movable chute at the second position by driving the shifter, and
the controller is configured to execute the first mode in a double-sided printing in which printing to a first surface of a particular sheet is performed and then printing to a second surface of the particular sheet is performed, in at least one of
throughout a period in which the printing to the first surface is performed and in which the particular sheet is nipped by the image carrier and the transfer roller and nipped by the heating rotary body and the rotary body, or
throughout a period in which the printing to the second surface is performed and in which the particular sheet is nipped by the image carrier and the transfer roller and nipped by the heating rotary body and the rotary body.

2. The image forming apparatus according to claim 1, wherein a distance between the second position and a straight line connecting a downstream end in the conveyance direction of the transfer nip region and an upstream end in the conveyance direction of the fusing nip region as viewed in an axial direction of the transfer roller is larger than a distance between the first position and the straight line as viewed in the axial direction.

3. The image forming apparatus according to claim 1, wherein
the controller is configured to execute:
the second mode, in at least a part of the period in which the printing to the first surface is performed and in which the particular sheet is nipped by the image carrier and the transfer roller and nipped by the heating rotary body and the rotary body; and
the first mode throughout the period in which the printing to the second surface is performed and in which the particular sheet is nipped by the image carrier and the transfer roller and nipped by the heating rotary body and the rotary body.

4. The image forming apparatus according to claim 3, wherein
the controller is configured to stop executing of the second mode and start executing of the first mode in a period in which the printing to the first surface of the particular sheet is performed and at a timing after an upstream end in the conveyance direction of the particular sheet has left the transfer nip region and before the upstream end reaches the fusing nip region.

5. The image forming apparatus according to claim 3, wherein
the controller is configured to start executing of the second mode in a period in which the printing to the first surface of the particular sheet is performed and at a timing after a downstream end in the conveyance direction of the particular sheet has reached the fusing nip region and before an upstream end in the conveyance direction of the particular sheet leaves the transfer nip region.

6. The image forming apparatus according to claim 1, wherein
the controller is configured to, in a case where a second particular sheet is conveyed after a first particular sheet in the double-sided printing process:
execute the second mode, in at least a part of a period in which printing to a first surface of the first particular sheet is performed and in which the first particular sheet is nipped by the image carrier and the transfer roller and nipped by the heating rotary body and the rotary body;
execute the first mode, throughout a period in which printing to a second surface of the first particular sheet is performed and in which the first particular sheet is nipped by the image carrier and the transfer roller and nipped by the heating rotary body and the rotary body;
execute the first mode, throughout a period in which printing to a first surface of the second particular sheet is performed and in which the second particular sheet is nipped by the image carrier and the transfer roller and nipped by the heating rotary body and the rotary body; and
execute the first mode, throughout a period in which printing to a second surface of the second particular sheet is performed and in which the second particular sheet is nipped by the image carrier and the transfer roller and nipped by the heating rotary body and the rotary body.

7. The image forming apparatus according to claim 1, wherein
the controller is configured to execute:
the first mode, throughout the period in which printing to the first surface is performed and in which the particular sheet is nipped by the image carrier and the transfer roller and nipped by the heating rotary body and the rotary body; and
the first mode, throughout the period in which printing to the second surface is performed and in which the particular sheet is nipped by the image carrier and the transfer roller and nipped by the heating rotary body and the rotary body.

8. The image forming apparatus according to claim 1, wherein
the controller is configured to execute:
the first mode, throughout the period in which the printing to the first surface is performed and in which the particular sheet is nipped by the image carrier and the transfer roller and nipped by the heating rotary body and the rotary body; and
the second mode, in at least a part of the period in which printing to the second surface is performed and in which the particular sheet is nipped by the image carrier and the transfer roller and nipped by the heating rotary body and the rotary body.

9. The image forming apparatus according to claim 8, wherein
the controller is configured to start executing of the second mode in a period in which the printing to the second surface of the particular sheet is performed and at a timing after a downstream end in the conveyance direction of the particular sheet has reached the fusing nip region and before an upstream end in the conveyance direction of the particular sheet leaves the transfer nip region.

10. The image forming apparatus according to claim 1, wherein
the shifter includes:
a spring configured to bias the movable chute to the first position; and
a solenoid actuator configured to move the movable chute from the first position to the second position against a biasing force of the spring.

11. The image forming apparatus according to claim 10, wherein
the movable chute includes a guide surface configured to guide the sheet; and
the shifter includes a pressing surface configured to press the movable chute from a side, of the movable chute, in which the guide surface is located.

12. The image forming apparatus according to claim 11, further comprising a link mechanism configured to move based on a driving force of the solenoid actuator, wherein
the link mechanism includes:
a first link movable in the axial direction of the transfer roller, a first end of the first link being connected to the solenoid actuator;
a second link pivotable about a first axis based on a movement of the first link, the second link being connected to a second end, opposite to the first end, of the first link; and
a third link having the pressing surface, the third link being connected to the second link, the third link being configured to push the movable chute to the second position based on a pivot of the second link.

13. A control method for an image forming apparatus, the image forming apparatus including:
an image carrier;
a transfer roller, the transfer roller and the image carrier defining a transfer nip region between the transfer roller and the image carrier;
a fuser including:
a heating rotary body; and
a rotary body, the heating rotary body and the rotary body defining a fusing nip region between the heating rotary body and the rotary body;
a movable chute disposed between the transfer roller and the fuser in a conveyance direction of the sheet, the movable chute being movable between a first position and a second position; and
a shifter wherein
the transfer roller is configured to transfer a toner image on the image carrier to a sheet,
the fuser is configured to fuse the toner image transferred to the sheet,
the heating rotary body is configured to heat the sheet,
the movable chute is configured to guide the sheet,
the shifter is configured to move the movable chute, and
the image forming apparatus is capable of executing:
a first mode in which the image forming apparatus locates the movable chute at the first position by not driving the shifter; and
a second mode in which the image forming apparatus locates the movable chute at the second position by driving the shifter,
the method comprising executing the first mode in a double-sided printing in which printing to a first surface of a particular sheet is performed and then printing to a second surface of the particular sheet is performed, in at least one of
throughout a period in which the printing to the first surface is performed and in which the particular sheet is nipped by the image carrier and the transfer roller and nipped by the heating rotary body and the rotary body, or
throughout a period in which the printing to the second surface is performed and in which the particular sheet is nipped by the image carrier and the transfer roller and nipped by the heating rotary body and the rotary body.

14. The control method according to claim 13, wherein a distance between the second position and a straight line connecting a downstream end in the conveyance direction of the transfer nip region and an upstream end in the conveyance direction of the fusing nip region as viewed in an axial direction of the transfer roller is larger than a distance between the first position and the straight line as viewed in the axial direction.

15. A non-transitory and computer-readable medium storing a program executable by a controller of an image forming apparatus, the image forming apparatus including:
an image carrier;
a transfer roller, the transfer roller and the image carrier defining a transfer nip region between the transfer roller and the image carrier;
a fuser including:
a heating rotary body; and
a rotary body, the heating rotary body and the rotary body defining a fusing nip region between the heating rotary body and the rotary body;
a movable chute disposed between the transfer roller and the fuser in a conveyance direction of the sheet, the movable chute being movable between a first position and a second position;
a shifter; and
the controller, wherein
the transfer roller is configured to transfer a toner image on the image carrier to a sheet,
the fuser is configured to fuse the toner image transferred to the sheet,
the heating rotary body is configured to heat the sheet,
the movable chute is configured to guide the sheet,
the shifter is configured to move the movable chute,
the controller is capable of executing:
a first mode in which the controller locates the movable chute at the first position by not driving the shifter; and
a second mode in which the controller locates the movable chute at the second position by driving the shifter,
the program is configured to cause the controller to execute the first mode in a double-sided printing in which printing to a first surface of a particular sheet is performed and then printing to a second surface of the particular sheet is performed, in at least one of
throughout a period in which the printing to the first surface is performed and in which the particular sheet is nipped by the image carrier and the transfer roller and nipped by the heating rotary body and the rotary body, or
throughout a period in which the printing to the second surface is performed and in which the particular sheet is nipped by the image carrier and the transfer roller and nipped by the heating rotary body and the rotary body.

16. The non-transitory and computer-readable medium according to claim 15, wherein a distance between the second position and a straight line connecting a downstream end in the conveyance direction of the transfer nip region and an upstream end in the conveyance direction of the fusing nip region as viewed in an axial direction of the transfer roller is larger than a distance between the first position and the straight line as viewed in the axial direction.
